(19) United States
(12) Patent Application Publication
(10) Pub. No.: US 2012/0085208 A1
(43) Pub. Date: Apr. 12, 2012

(54) Pattern Cutting System

(75) Inventors: Yoko Supernavage, Clifton, NJ (US); Jessica Mellon, Clifton, NJ (US); Ross Exley, Clifton, NJ (US)

(73) Assignee: EK Success Ltd., Clifton, NJ (US)

(21) Appl. No.: 13/197,016

(22) Filed: Aug. 3, 2011

Related U.S. Application Data
(60) Provisional application No. 61/391,371, filed on Oct. 8, 2010.

(51) Int. Cl. B26D 7/00; B43L 13/20; B26D 1/00

(52) U.S. Cl. 83/13; 83/821; 33/562

(57) ABSTRACT

There is disclosed herein a system, methods and device for creating three-dimensional decorations. The system, devices and methods disclosed operate to facilitate quick creation of relatively inexpensive and reproducible three-dimensional decorations from most any cuttable material. A pattern cutting system includes a two-part template and a cutter having a cutting blade. The template includes substantially planar first and second portions, each with a plurality of grooves therein, the cutting blade of the cutter fitting within the grooves to effectively cut material. The two portions are preferably hinged together, for example, by a living hinge, to be foldable such that the grooves in each portion align. A cuttable material, such as paper, is sandwiched and retained between the first portion and the second portion while the cutter cuts the material along the plurality of grooves.

### CROSS-REFERENCE TO RELATED APPLICATIONS

This application claims the benefit of U.S. patent application Ser. No. 61/391,371 filed on Oct. 8, 2010.

### TECHNICAL FIELD OF THE INVENTION

The present system and methods are related to relatively inexpensive devices for creating decorations. Particularly, the system and methods relate to templates and cutters which facilitate production of hanging three-dimensional decorations.

### BACKGROUND OF THE INVENTION

The creation of three-dimensional decorations from cutting and folding different materials, such as paper stock and the like, is well-known. Children and adults alike have taken scissors to paper to create snowflakes and various unfurling hanging designs. The difficulty in reproducing such designs led to the use of cutting templates.

Templates typically operate to either mark the material for cutting or allow the user to cut the material using guide slots provided on the template. In either case, the template must be placed on top of the material to be cut, which is generally spread upon a table top or the like, and the two components—i.e., the material and template—must be held firmly by the user to effect the desired cutting pattern. This process can be difficult for many, specifically where several cuts are required.

The present system, device and methods solve the numerous problems associated with creating reproducible, three-dimensional decorations from cuttable material. The system allows for quick and easy creation of inexpensive, reproducible, three-dimensional decorations from an assortment of flexible, cuttable materials. The present system accomplishes these and other goals without sacrificing creativity, aesthetics and simplicity.

### SUMMARY OF THE INVENTION

There is disclosed herein a system and methods for creating three-dimensional decorations which avoid disadvantages of prior system, devices and methods while affording structural and operating advantages. The system, devices and methods disclosed operate to facilitate quick creation of relatively inexpensive and reproducible three-dimensional decorations from most any cuttable material.

In one embodiment, a pattern cutting system comprises a two-part template and a cutter having a cutting blade. The template includes substantially planar first and second portions, each with a plurality of grooves therein, the cutting blade of the cutter fitting within the grooves to effectively cut material. The two portions are preferably hinged together, for example, by a living hinge, to be foldable such that the grooves in each portion align. A cuttable material, such as paper, is sandwiched and retained between the first portion and the second portion while the cutter cuts the material along the plurality of grooves.

In a preferred embodiment of the disclosed pattern cutting system, the first and second portions are identical in size and shape. The first and second portions may be most any shape, but are preferably shaped like one of either a rectangle or a triangle.

In an embodiment, the cutter comprises a guide member to prevent cutting of the first and second portions by the blade as it moves through each. The guide member extends from the cutter to be proximate and parallel to the preferably retractable blade.

In a preferred method for creating three-dimensional decorations, the cuttable material is first sandwiched between the first template portion and the second template portion. Then, the cutting blade is moved through each of the plurality of grooves to thereby cut the material. The cut material is then removed from between the first and second template portions and is manipulated to form a three-dimensional decoration. In an embodiment of the method, a plurality of cut material is joined together to form the desired decoration.

Finally, a cutting template is also set forth. The template comprises a first portion having a plurality of cutting grooves therein, and a second portion hingeably attached to the first portion and having a plurality of cutting grooves therein, wherein the plurality of cutting grooves of the second portion align with the plurality of cutting grooves of the first portion when the two portions are overlapped.

In various embodiments, the cutting grooves of the template portions are either all parallel or arranged in at least two groups of parallel grooves. Similarly, the plurality of cutting grooves may be provided in all the same lengths or in various patterned or random lengths.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of a template for the present pattern cutting system;

FIG. 2 is a perspective view of the template of FIG. 1 in an open position;

FIG. 3 is a perspective view of another embodiment of a template for the present pattern cutting system;

FIG. 4 is another perspective view of the template of FIG. 3 in the process of opening;

FIG. 5 is still another perspective view of the template of FIG. 3 in an open position;

FIG. 6 is a perspective view of an embodiment of a cutter made in accordance with the present pattern cutting system;

FIG. 7 is a side view of the cutter of FIG. 6;

FIG. 8 is a rear perspective view of another embodiment of a template for the present pattern cutting system;

FIG. 9 is a front perspective view of the template of FIG. 8;

FIG. 10 is a perspective view of the template of FIG. 8 in an open position;

FIG. 11 is a perspective view of another embodiment of a cutter for use in the present pattern cutting system;

FIG. 12 is a side view of the cutter of FIG. 11; and

FIGS. 13, 14 and 15 illustrate possible decorative ornaments which can be crafted using the embodiments of the present pattern cutting system.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated. It should be noted that the features illustrated in the drawings may not necessarily reflect the proper scale, and, unless mutually exclusive or specifically stated otherwise, features of one embodiment may be employed with other embodiments as the skilled artisan would recognize. Descriptions of well-known components and processes may be omitted as to not unnecessarily obscure the embodiments of the invention. The examples used herein are intended merely to facilitate an understanding of ways in which the invention may be practiced and to further enable those of skill in the art to practice embodiments of the invention. Finally, it is noted that like reference numbers represent similar parts throughout the specification and the various views of the drawings.

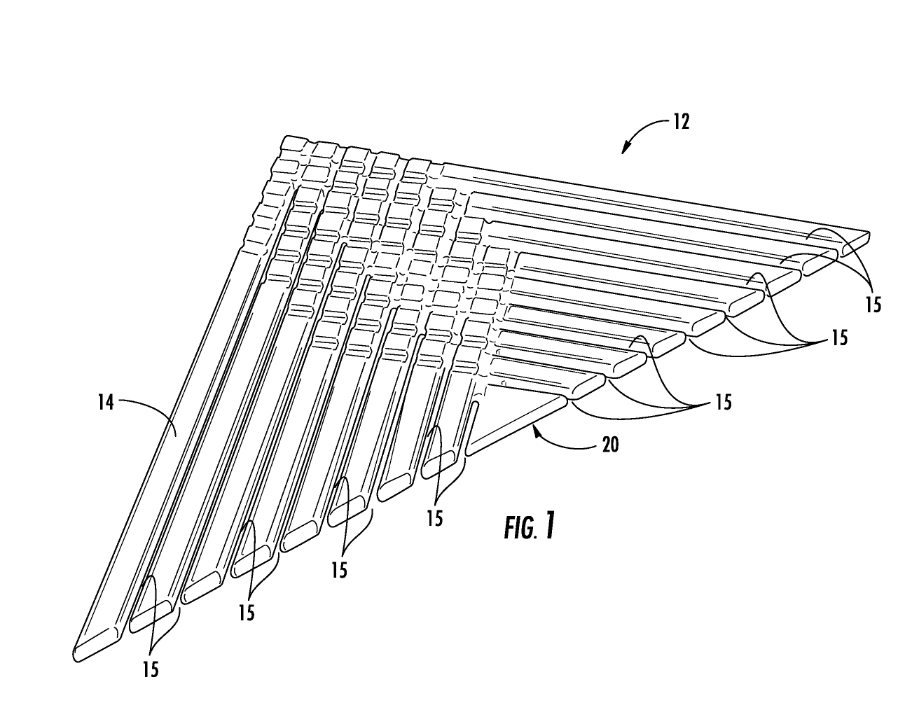

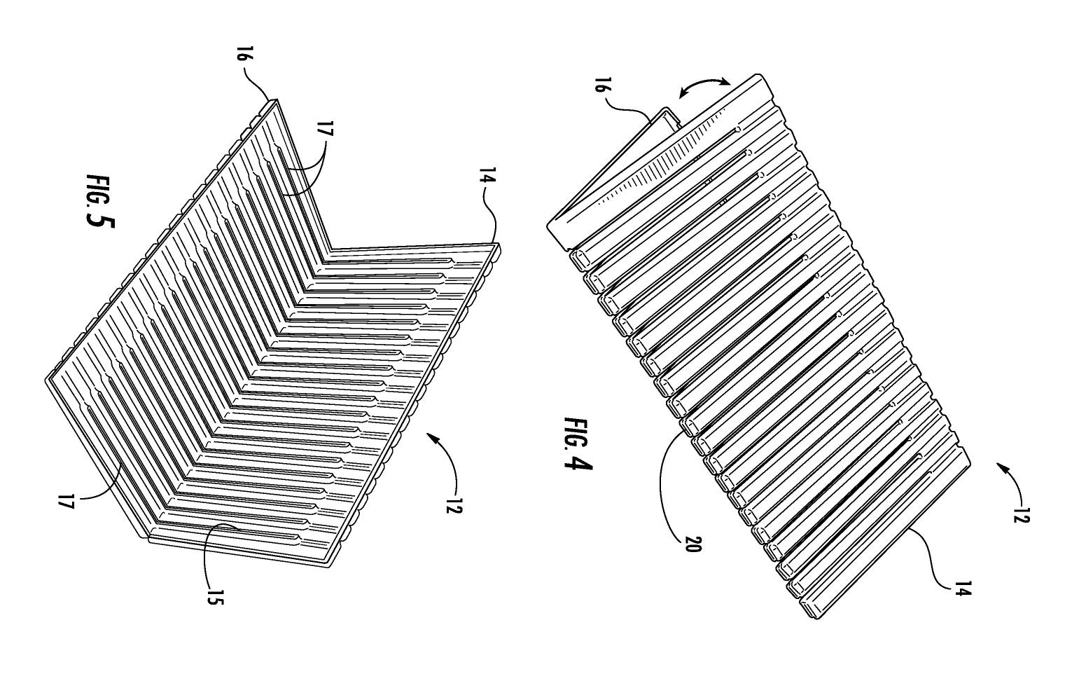

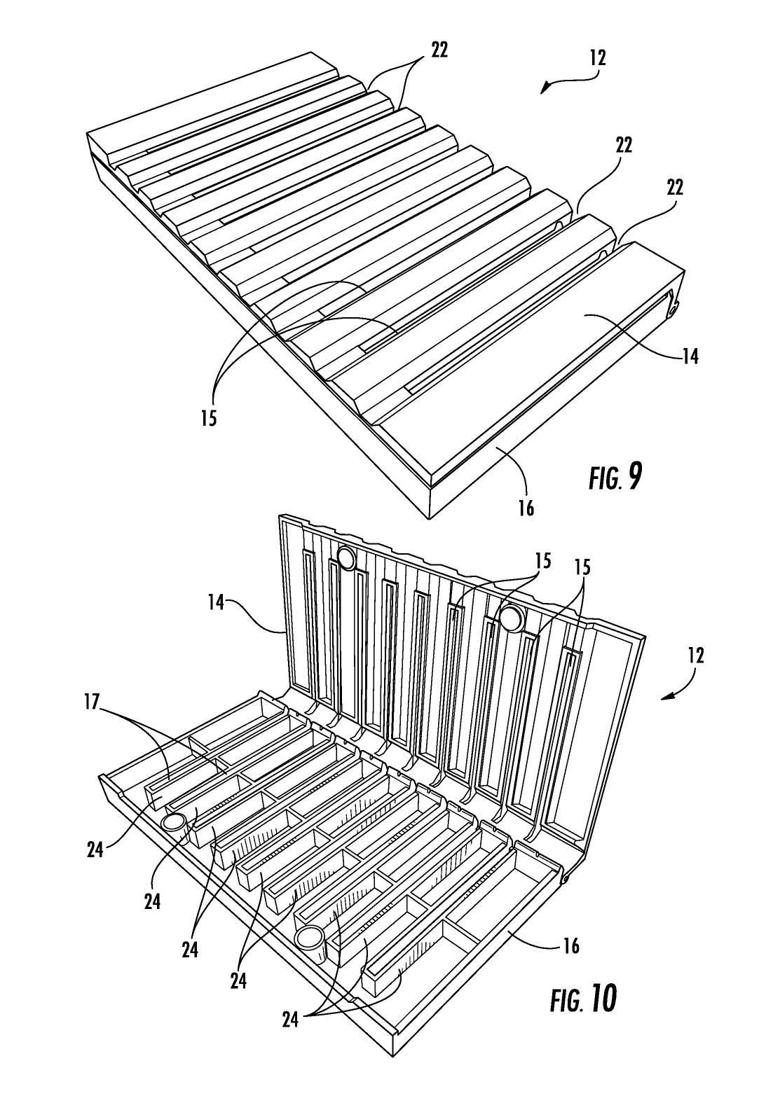

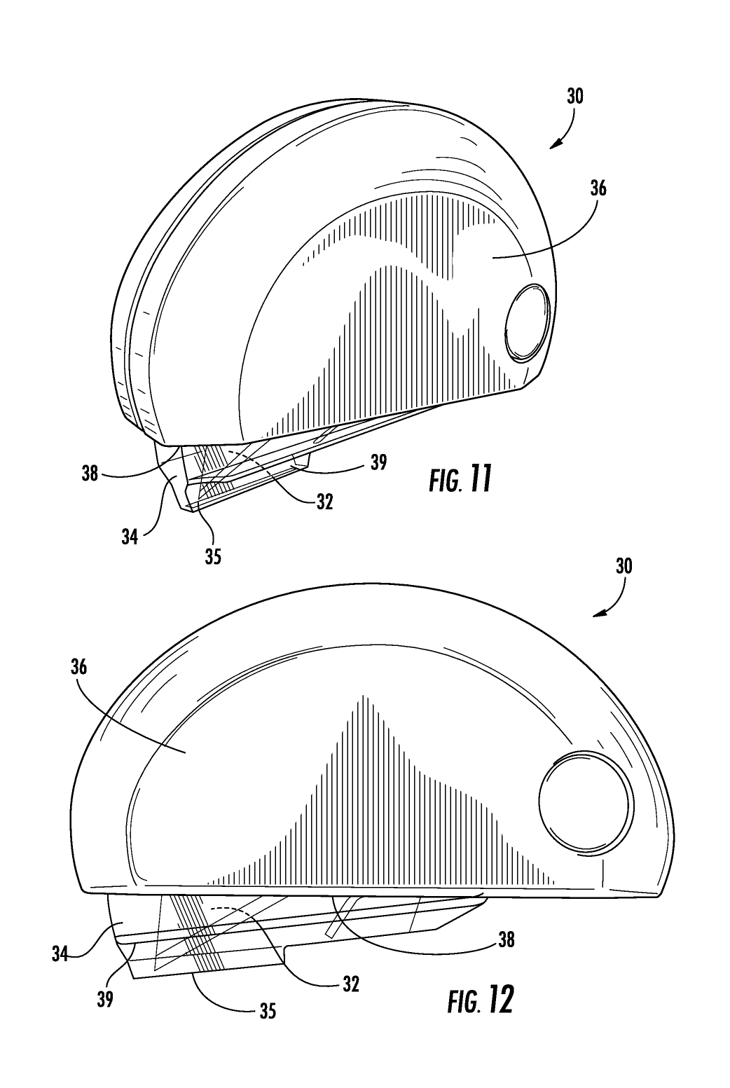

Referring now to FIGS. 1-12, there are illustrated various aspects and embodiments of a pattern cutting system, generally identified by the number 10 throughout the appended drawing figures. The cutting system 10 comprises a template 12 having a substantially planar first portion 14 with a plurality of grooves 15 therein and a substantially planar second portion 16 with a plurality of grooves 17 therein, and a cutter 30 having a blade 32 extending there from and capable of fitting within the grooves 15 and 17 of the template portions, 14 and 16.

In the embodiments of FIGS. 1-5, two embodiments of the template 12 are illustrated. In each, the first portion 14 and the second portion 16 are preferably identical in size and shape with aligned peripheries. Rectangular and triangular shapes are shown and provide the most common three-dimensional decoration. However, circular, oval and most any polygonal shape may also be used for the template 12. Further, the size and shape of the two portions 14 and 16 could conceivably be different from one another for certain applications. The possibilities are innumerable and are limited only by the imagination and creativity of a manufacturing entity.

For ease of use, the two portions 14 and 16 are preferably connected to one another along aligned edges 19. A hinge 20 is used to allow the two portions to pivot apart in order to accept cuttable material there between. The hinge 20 may be most any type of hinge, including a simple living hinge and a more complex slot-and-pin type hinge.

As shown, the first portion 14 and the second portion 16 together sandwich and retain a cuttable material, while the blade 32 of the cutter 30 is used to cut the material along the plurality of grooves 15 and 17.

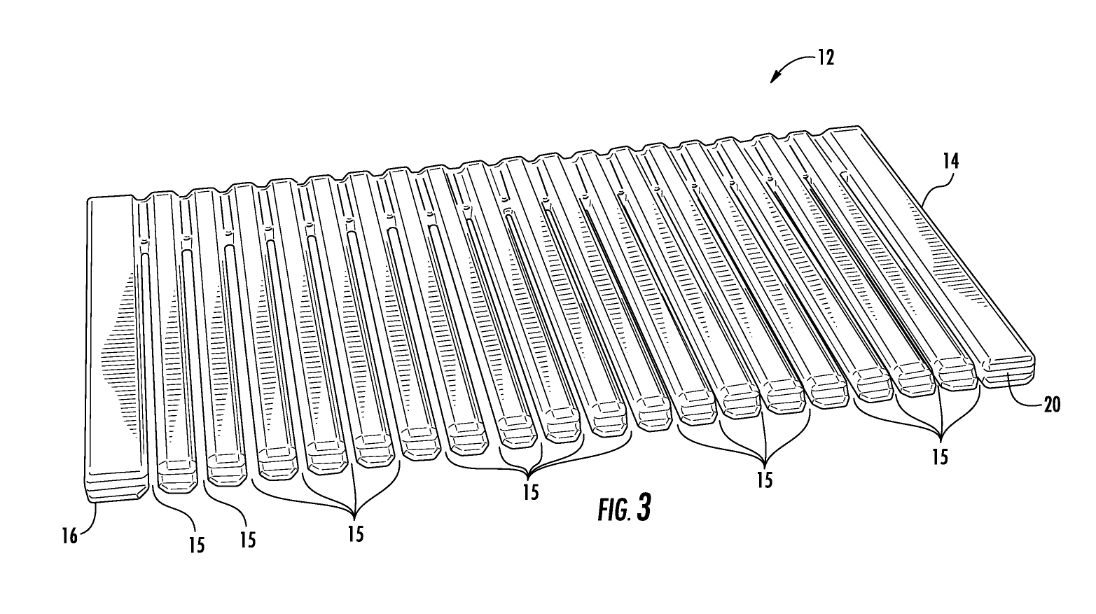

Turning to the two individual portions, 14 and 16, an embodiment of the system 10 can be more readily understood. In the embodiment of FIG. 1, the first portion 14 has the shape of a triangle, while the first portion 14 of the embodiment of FIG. 3 is in the shape of a rectangle. Similarly, the second portion 16 in FIGS. 1 and 3 are identical in size and shape to the respective first portions 14. The grooves 15 and 17 of the embodiment of FIG. 1 are shown to be arranged in two groups, each group of grooves spaced from and running parallel to an edge of the triangle. As can be seen, the grooves are of varying lengths, decreasing in length as the distance from the parallel edge increases. The grooves 15 and 17 of the embodiment of FIG. 3, are arranged in a single group of uniform size. Numerous other variations and combinations are possible.

In the illustrated embodiment of FIGS. 8-10 (only the rectangular embodiment is illustrated), the template 12 is configured somewhat differently to accomplish a similar result. That is, the grooves 15 pass completely through the first portion 14 and the thickness of the first portion 14 is less than the length of the cutter blade 32. Further, an upper surface opening 22 of each groove 15 of the first portion has a beveled entry. The inward sloped edges of the upper surface opening 22 help guide the cutter 30 into and along each groove. While the grooves 15 do not extend the full length of the first portion surface, the opening 22 does extend between two sides to continue guiding the cutter 30, as will be explained in further detail below.

The second portion 16 of pattern cutting template 12 of this embodiment is similar, if not identical to the first portion 14 in size and shape. However, in a preferred embodiment the second portion 16 has a plurality of grooves 17 each comprised of a walled-channel 24 extending from an inner surface 26 of the second portion 16 and aligning with a groove in the first portion 14. The walled-channels 24 provide depth to the grooves 17 to prevent the cutter blade 32 from passing entirely through the template 12. In fact, the walled-channels 24 are closed at the inner surface 26, thereby preventing a longer blade, for example, from passing entirely through the template 12. This feature allows the system 10 to be used without the need of a cutting surface on which to place the template 12.

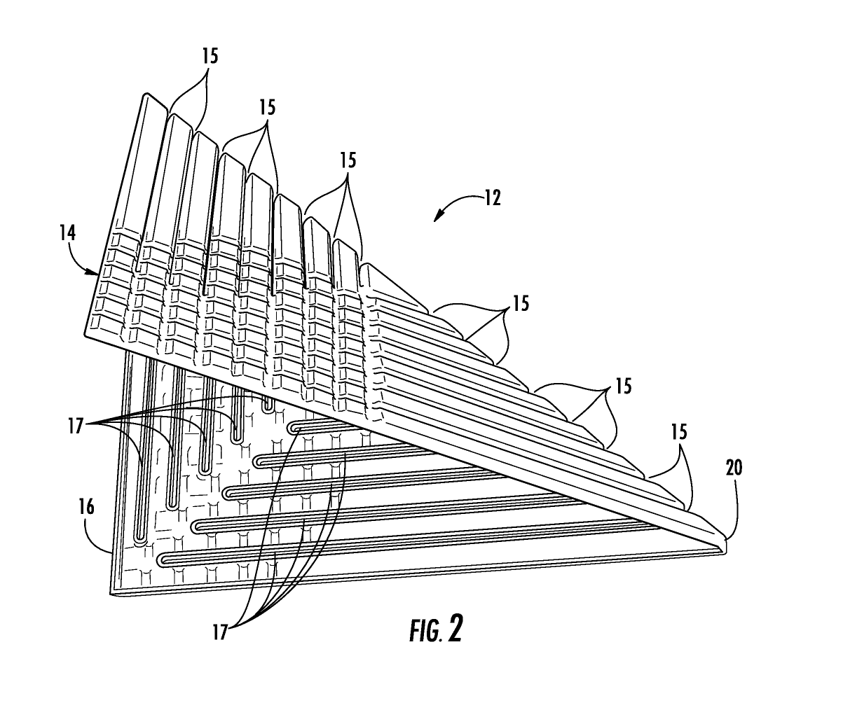

Conversely, in the first alternate embodiments shown in FIGS. 1-2 (triangular template) and FIGS. 3-5 (rectangular template), the overall thickness of the template 12 prevents the cutting blade 32 from extending out the opposing side. That is, while the cutting grooves 15 are present on both the first portion 14 and the second portion 16, the blade is prevented from cutting any surface placed under the template because it is too short to extend there through. An advantage of this embodiment is that the template 12 is reversible and either portion, 14 or 16, may be used as the upward or cutting side.

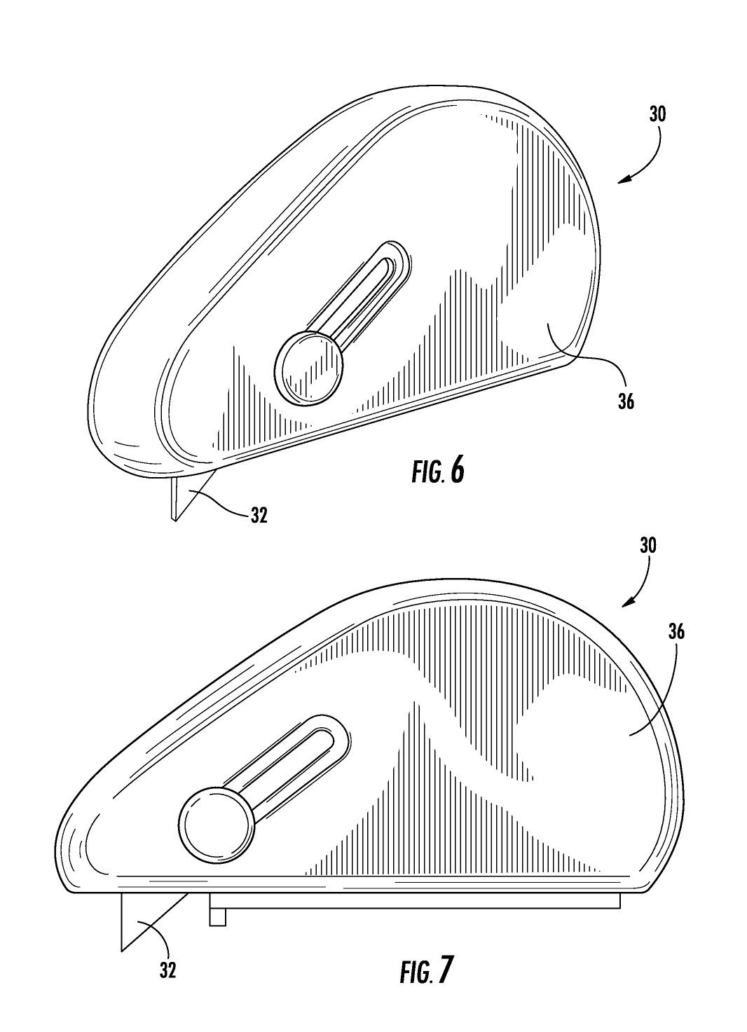

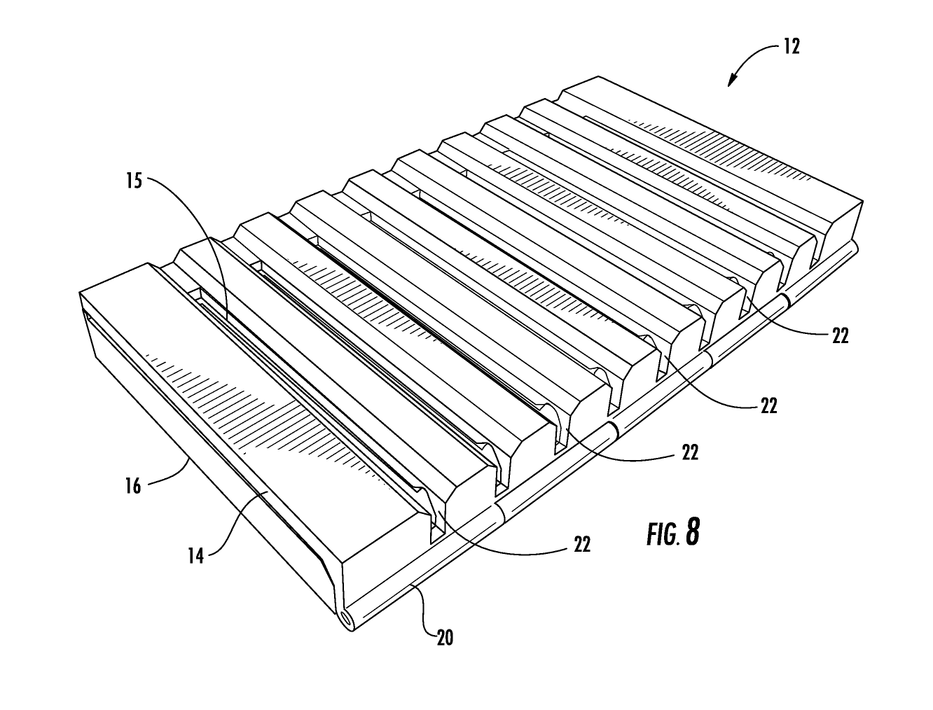

As to the cutter 30, numerous embodiments are possible. The basic components of the cutter 30 include a body or housing 36 and a blade 32. Two distinct embodiments of the cutter 30 are illustrated in the accompanying drawings. In a first embodiment, the blade 32 is retractable, as shown in FIGS. 6-7 and as is well-known by those skilled in the art. This allows the blade 32 to be extended to a preferred cutting depth and to be retracted for safety after use. Alternatively, a second embodiment, shown in FIGS. 11 and 12, illustrates an cutter 30 having a movable shroud 34 which covers the extended blade 32.

With further reference to the embodiment of FIG. 11, the housing 36 is an ergonomic shape which fits readily within the hand of a user. At a bottom edge of the housing 36 is an opening 38 from which a movable shroud 34 extends. The blade 32 also extends from the opening 38 but less than the extent of the shroud 34. The shroud 34 is preferably pivotable within the opening 38 and includes a slit 35 within an end to allow protrusion of the blade 32. While the shroud 34 is biased outward by a spring or other member (not shown), it may be forced upward into the housing 36 to expose the blade 32 from the slit 35. Further, the downward surface 39 of the shroud is preferably configured to conform to the upper surface opening 22 of the first portion 14. This feature allows the cutter 30 to accurately track within the grooves 15. Of course, other indexing mechanisms may be employed to achieve the same or similar result.

With the broad features of the system 10, including the template 12 and the cutter 30 described, the operation of the system 10 may be more readily understood.

The method for creating three-dimensional decorations begins by sandwiching a piece of cuttable material, such as colored construction paper, between the first template portion 14 and the second template portion 16. The material may be folded before placing between the template portions, 14 and 16, if desired. Once the template portions are closed about the material, the cutter 30, via the shroud 34, is placed within one of the plurality of grooves 15 on the first portion 14 at an edge of the template 12. The cutter 30 is pushed downward, thereby forcing the shroud 34 into the cutter housing 36 and extending the blade 32, until the blade passes through the sandwiched material. Then, by moving the cutting blade 32 along the length of the groove 15, the sandwiched material is cut in the exact length and shape of the template groove. The cutter 30 is then lifted and moved to the next groove and the process repeated until the material has been cut along all desired grooves—note, for some applications, not all grooves need be used for every design.

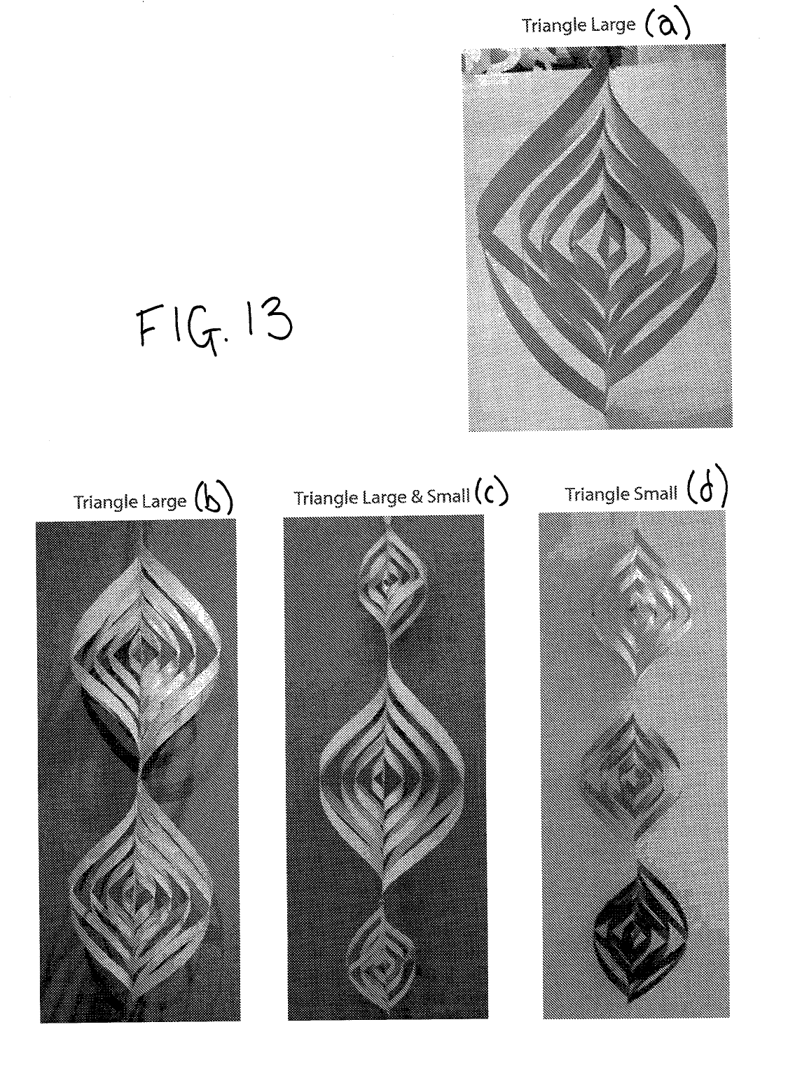

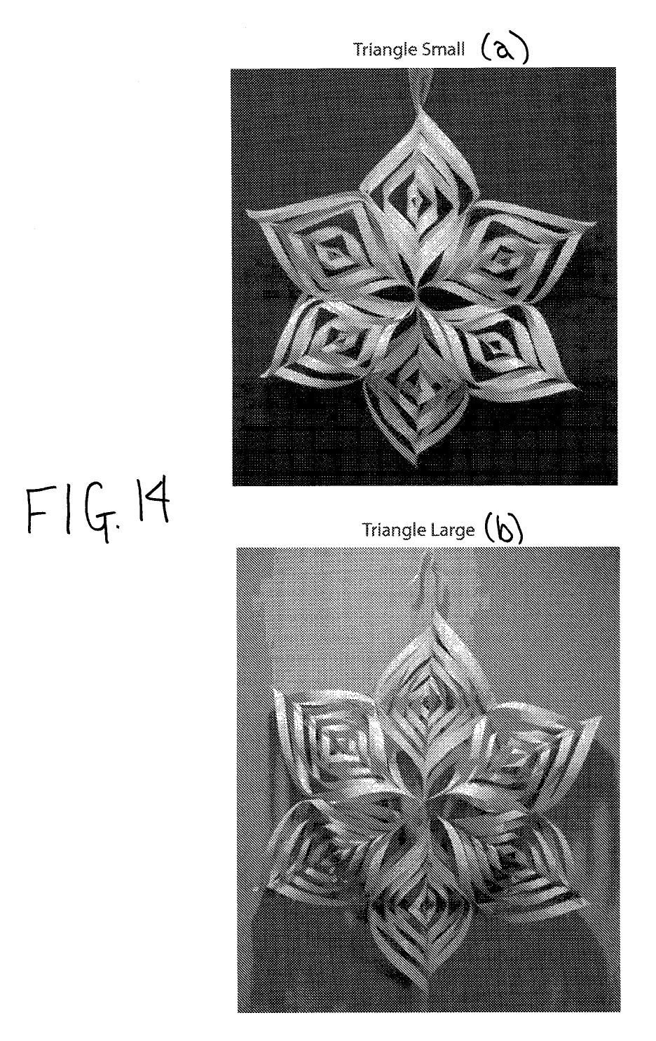

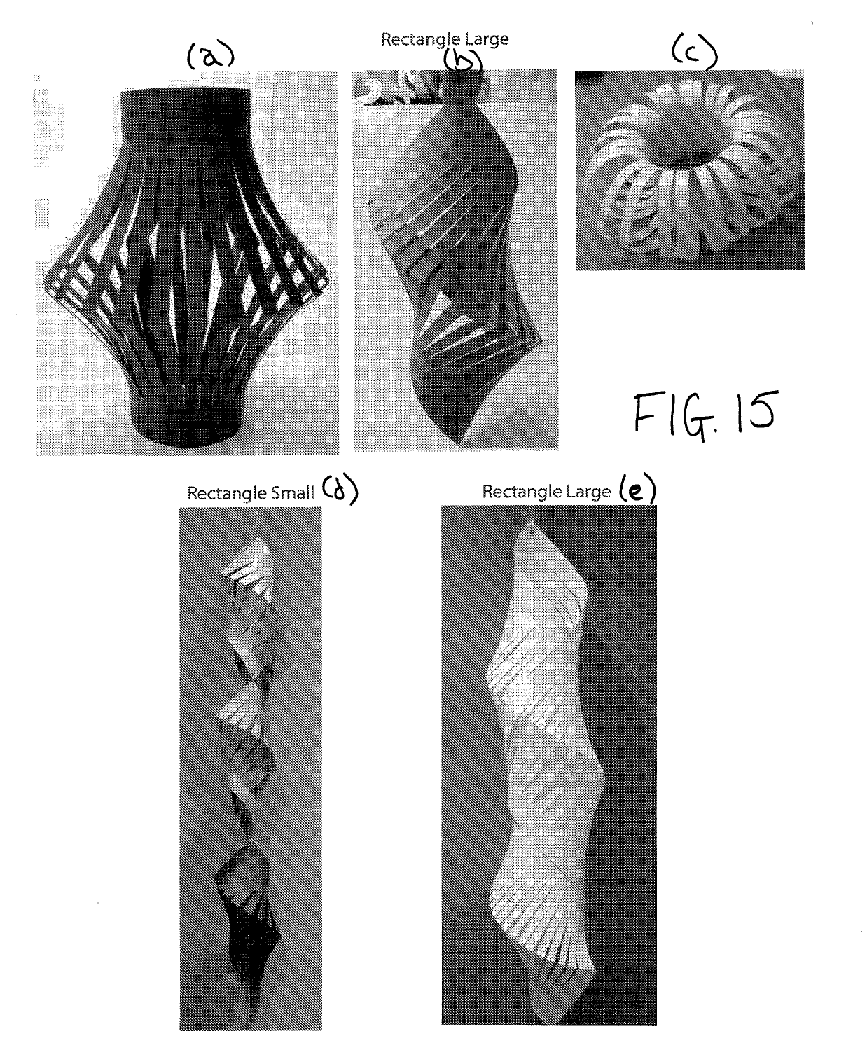

Finally, by removing the cut material from between the first and second template portions, 14 and 16, the material may be manipulated in a known manner to form the desired three-dimensional decoration. By joining a plurality of these cut material pieces together, an almost unlimited number of decorative ornamentations may be created. FIGS. 13, 14 and 15 illustrate just some of the possible decorative ornaments which may be quickly and easily crafted. The triangle template of FIG. 1 can be used to craft the ornament of FIG. 13(a) which is used to construct the ornaments of FIG. 13(b)-(d) by connecting multiple parts together, as well as the star ornaments of FIG. 14(a) and (b) made from six (6) individual parts. Likewise, the rectangular template of FIGS. 3 and 8 can be used to craft the individual ornaments of FIG. 15(a)-(c), which can be connected together to form the ornaments of FIG. 15(d) and (e).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A pattern cutting system comprising:
a template having a substantially planar first portion with a plurality of grooves therein and a substantially planar second portion with a plurality of grooves therein; and
a cutter having a blade extending there from and capable of fitting within the grooves of the template portions;
wherein the first portion and the second portion sandwich and retain a cuttable material while the cutter cuts the material along the plurality of grooves.

2. The pattern cutting system of claim 1, wherein the first portion and second portion are connected along aligned edges.

3. The pattern cutting system of claim 2, wherein the first and second portions are connected by a hinge.

4. The pattern cutting system of claim 1, wherein the first and second portions are identical in size and shape.

5. The pattern cutting system of claim 1, wherein each of the plurality of grooves in the second portion comprises a walled-channel extending from a surface of the second portion.

6. The pattern cutting system of claim 5, wherein each of the plurality of grooves in the first portion pass through a top and bottom surface of the first portion.

7. The pattern cutting system of claim 6, wherein the plurality of grooves of the first portion align with the plurality of grooves of the second portion.

8. The pattern cutting system of claim 1, wherein the first and second portions are shaped like a rectangle.

9. The pattern cutting system of claim 1, wherein the first and second portions are shaped like a triangle.

10. The pattern cutting system of claim 1, wherein the grooves of the first portion align with the grooves of the second portion.

11. The pattern cutting system of claim 1, wherein the cutter comprises a guide member to prevent cutting of the first and second portions by the blade.

12. The pattern cutting system of claim 11, wherein the guide member extends from the cutter parallel to the blade.

13. The pattern cutting system of claim 11, wherein the blade is retractable into the cutter.

14. The pattern cutting system of claim 1, wherein the blade extends a distance greater than a thickness of the first portion and less than a thickness of the template.

15. A method for creating three-dimensional decorations, the method comprising:
sandwiching a cuttable material between a first template portion and a second template portion, wherein the first and second template portions have a plurality of aligned grooves;
moving a cutting blade through each of the plurality of grooves to thereby cut the material;
removing the cut material from between the first and second template portions; and
manipulating the cut material to form a three-dimensional decoration.

16. The method of claim 15, wherein the first template portion and the second template portion are identical in size and shape and are hinged together along aligned edges.

17. The method of claim 16, wherein the step of sandwiching comprises the steps of:
placing a cuttable material on an interior surface of the first portion, and
folding the two template portions together.

18. The method of claim 15, further comprising the step of folding the cuttable material before sandwiching between the first and second template portions.

19. The method of claim 15, wherein the step of manipulating comprises the step of joining a plurality of cut material together.

20. The method of claim 15, wherein the step of moving the cutting blade through the grooves comprises the step of contacting the first template portion with a cutter having a cutting blade, and exposing the cutting blade a distance greater than the thickness of the first template portion and less than a combined thickness of the first and second template portions.

21. A cutting template comprising:
a first portion having a plurality of cutting grooves passing there through;
a second portion hingeably attached to the first portion and having a plurality of cutting channels therein, wherein the plurality of cutting channels of the second portion align with the plurality of cutting grooves of the first portion when the two portions are overlapped.

22. The cutting template of claim 21, wherein the plurality of cutting channels are closed at a bottom end.

23. The cutting template of claim 21, wherein the plurality of cutting channels are open at a bottom end.

24. The cutting template of claim 21, wherein the first portion and the second portion are identical in size and shape.

25. The cutting template of claim 21, wherein the first portion and the second portion are rectangular.

26. The cutting template of claim 21, wherein the first portion and the second portion are triangular.

27. The cutting template of claim 25, wherein the plurality of cutting grooves are all parallel.

28. The cutting template of claim 26, wherein the plurality of cutting grooves are arranged in at least two groups of parallel grooves.

29. The cutting template of claim 27, wherein the plurality of cutting grooves are all the same length.

30. The cutting template of claim 28, wherein the plurality of cutting grooves are various lengths.
